(19) United States
(12) Patent Application Publication
(10) Pub. No.: US 2017/0005479 A1
(43) Pub. Date: Jan. 5, 2017

(54) POWER PLANT

(71) Applicant: SIEMENS AKTIENGESELLSCHAFT, Muenchen (DE)

(72) Inventors: HANS-GUENTER ECKEL, ROSTOCK (DE); MAGDALENA GIERSCHNER, ROSTOCK (DE); HANS-JOACHIM KNAAK, ERLANGEN (DE)

(21) Appl. No.: 15/106,519

(22) PCT Filed: Dec. 2, 2014
(86) PCT No.: PCT/EP2014/076204

§ 371 Date: Jun. 20, 2016

(30) Foreign Application Priority Data
Dec. 20, 2013 (DE) 10 2013 226 987.0

(51) Int. Cl. H02J 3/38; F03D 9/00; F03D 7/04; H02J 3/36; H02J 3/40

(52) U.S. Cl. CPC H02J 3/386; H02J 3/36; H02J 3/40; F03D 7/048; F03D 9/005; H02J 3/383

(57) ABSTRACT

A power plant contains an internal AC voltage grid, electrical energy generation units which are connected to the internal AC voltage grid, and a HVDC transmission device, which is connected to the internal AC voltage grid, is connectable to an external AC voltage grid via a DC link and enables energy transmission from the internal AC voltage grid in the direction of the external AC voltage grid. The energy generation units feed their power into the internal AC voltage grid via a power electronics converter. The energy generation units each have a synchronization device, which is suitable for regulating the generation of the output voltage of the respective energy generation unit such that the phase angle of the output voltage has a setpoint phase angle, which is preset to the respective energy generation unit, with respect to a synchronization signal applied on the input side.

The invention relates to a power plant with an internal AC voltage grid, a multiplicity of electrical energy generation units, which are connected to the internal AC voltage grid, and at least one HVDC transmission device, which is connected to the internal AC voltage grid, is connectable to an external AC voltage grid via a DC link, and enables energy transmission from the internal AC voltage grid in the direction of the external AC voltage grid.

Power plants of the type described are known in the form of wind farms, in which the energy generation units are configured as wind turbines, or as photovoltaic parks, in which the energy generation units are configured as photovoltaic installations. The HVDC transmission devices used in these power plants, on the internal AC voltage grid side of the respective power plant, have self-commutated rectifiers.

The object of the invention is the proposal of a power plant which can be constructed more cost-effectively than previous power plants.

This object is fulfilled according to the invention by a power plant with the characteristics described in claim 1. Advantageous configurations of the power plant according to the invention are described in the sub-claims.

According to the invention, it is provided that the energy generation units either feed their power into the internal AC voltage grid via a power electronics converter, or feed their power into the internal AC voltage grid via the stator of a double-fed asynchronous machine, the rotor of which is fed via a power electronics converter, and that each of the energy generation units has a synchronization device, which is suitable for regulating the generation of the output voltage of the respective energy generation unit or the feeding of the output current of the respective energy generation unit such that the phase angle of the output voltage or the phase angle of the output current has a setpoint phase angle which is preset to the respective energy generation unit, with respect to a synchronization signal applied on the input side.

The power plant according to the invention has a key advantage in that, in the latter, the HVDC transmission device on the internal AC voltage grid side does not need to be self-commutated, but can be line-commutated. In other words, in the power plant according to the invention, it is possible, on the internal AC voltage grid side, to use line-commutated rectifiers in place of self-commutated rectifiers, thereby resulting in substantial cost savings, given that line-commutated rectifiers are technically simpler and, accordingly, can be manufactured more cost-effectively than self-commutated rectifiers. The use of a line-commutated HVDC transmission device on the internal AC voltage grid side is possible according to the invention, on the grounds that sufficient stabilization of the internal AC voltage grid is achieved by the synchronization of the energy generation units, such that self-commutation of the HVDC transmission device on the internal AC voltage grid side is not required.

As already mentioned, in the interests of minimum costs, it is considered advantageous if the HVDC transmission device, on the connection side to the internal AC voltage grid, has at least one line-commutated rectifier. In other words, on the connection side to the internal AC voltage grid, the HVDC transmission device is preferably a line-commutated HVDC transmission device.

Overall, it is advantageous if the HVDC transmission device, on the side of the internal AC voltage grid, is a line-commutated HVDC transmission device and, on the side of the external AC voltage grid, is a self-commutated HVDC transmission device.

For emergency operation, or for the secure coverage of the internal load demand of the internal AC voltage grid even in the event of insufficient energy generation from the energy generation units, it is considered advantageous if the HVDC transmission device on the connection side to the internal AC voltage grid has at least one self-commutated rectifier which is capable of functioning as an inverter and, for the coverage of the internal load demand of the internal AC voltage grid, can inject energy delivered on the DC side of the HVDC transmission device into the internal AC voltage grid. Due to the presence of a self-commutated rectifier, which is capable of functioning as an inverter, it is possible to execute an energy transfer from the external AC voltage grid in the direction of the internal AC voltage grid, in the event of an insufficient grid voltage on the latter.

Preferably, all the energy generation units in the power plant receive the same synchronization signal.

In the interests of an exceptionally high stability of the internal AC voltage grid, it is considered advantageous if, during the operation of the power plant, at least one half of the energy generation units is preset to the same setpoint phase angle, hereinafter designated as the central setpoint phase angle, and this half of the energy generation units generates its output voltage or its output current with the same central setpoint phase angle.

For the compensation of reactive power in the internal AC voltage grid, or for the generation of reactive power in the AC voltage grid, it may be provided that at least one of the energy generation units is preset, or can be preset, to an individual setpoint phase angle which deviates from the central setpoint phase angle.

For example, it may be provided that at least one energy generation unit is preset to an individual setpoint phase angle which deviates from the central setpoint phase angle by 90°, or else at least deviates therefrom such that the energy generation unit injects reactive power into the internal AC voltage grid.

Preferably, the power plant has a central device which is connected to all the energy generation units and is configured for the presetting of a respective setpoint phase angle on each of the energy generation units.

In the interests of the simple transmission of the synchronization signal, it is considered advantageous if each of the energy generation units has a radio receiver, and the radio receivers of the energy generation units receive their respective synchronization signal by wireless transmission.

The synchronization signal, for example, may be a “GPS signal” (GPS: global positioning system); in this case, the radio receivers are preferably GPS receivers.

The power plant may be, for example, a wind farm or a photovoltaic park, in which the energy generation units are configured as wind turbines and/or as photovoltaic installations.

The internal AC voltage grid may be, for example, a multi-phase grid system, in particular a three-phase AC grid system.

The invention also relates to an energy generation unit for a power plant of the type described above. According to the invention, it is provided that an energy generation unit of this type has a synchronization device, which is designed for the processing of an input-side synchronization signal and the phase angle of an output voltage generated by the energy generation unit, or the phase angle of an output current injected by the energy generation unit into the internal AC voltage grid, and for the regulation of the generation of the output voltage or the injection of the output current such that the phase angle of the output voltage or the phase angle of the output current corresponds to a setpoint phase angle which is preset on the energy generation unit.

Regarding the advantages of the energy generation unit according to the invention, the reader is referred to the abovementioned embodiments described with reference to the power plant according to the invention, as the advantages of the energy generation unit according to the invention essentially correspond to those of the power plant according to the invention.

The invention also relates to a method for the operation of a power plant which is equipped with an internal AC voltage grid, a multiplicity of energy generation units, which are connected to the internal AC voltage grid, and at least one HVDC transmission device, which is connected to the internal AC voltage grid.

With regard to a method of this type, it is provided according to the invention that a synchronization signal is fed to each of the energy generation units, and that each of the energy generation units detects the input-side synchronization signal, together with the phase angle of an output voltage generated by the respective energy generation unit, or the phase angle of an output current injected into the internal AC voltage grid by the respective energy generation unit, and regulates the generation of the output voltage or the injection of the output current such that the phase angle of the output voltage or the phase angle of the output current corresponds to a setpoint phase angle which is preset on the respective energy generation unit, in relation to the synchronization signal.

Regarding the advantages of the method according to the invention, the reader is referred to the abovementioned embodiments described with reference to the power plant according to the invention.

The invention is described in greater detail below with reference to exemplary embodiments; herein, for exemplary purposes

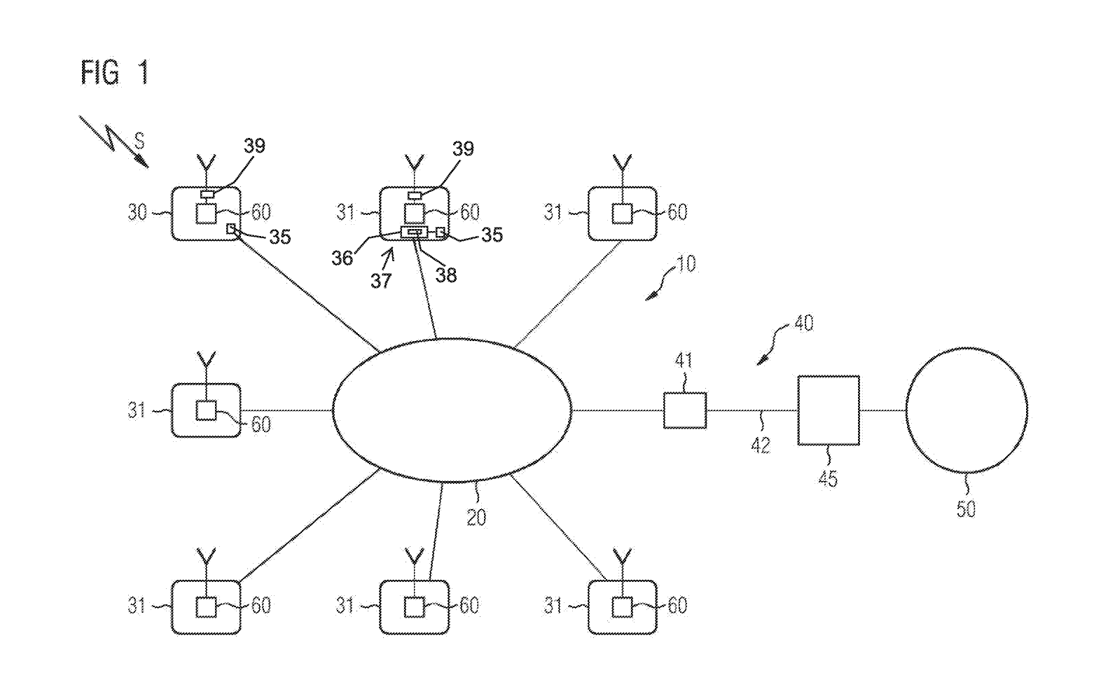

FIG. 1 shows an exemplary embodiment of a power plant according to the invention, in which a HVDC transmission device has a line-commutated rectifier on the internal AC voltage grid side;

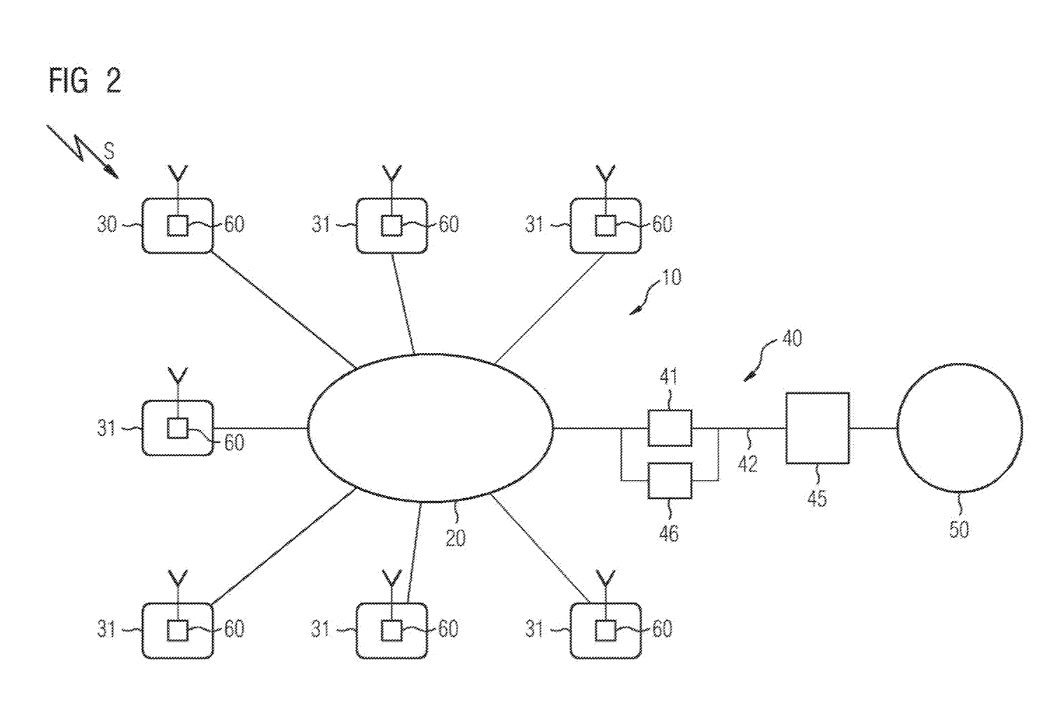

FIG. 2 shows an exemplary embodiment of a power plant according to the invention, in which a HVDC transmission device has both a self-commutated rectifier and a line-commutated rectifier on the internal AC voltage grid side;

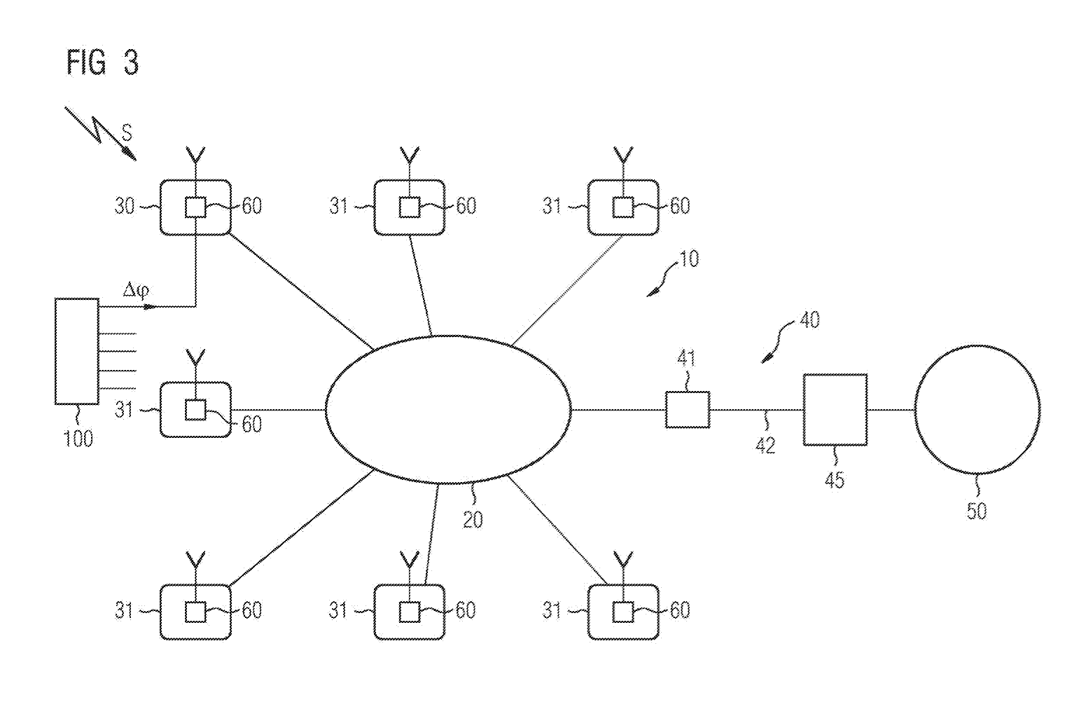

FIG. 3 shows an exemplary embodiment of a power plant according to the invention, in which a central device is provided which is connected to all of the energy generation units of the power plant and which presets an individual setpoint phase angle on each of the latter; and

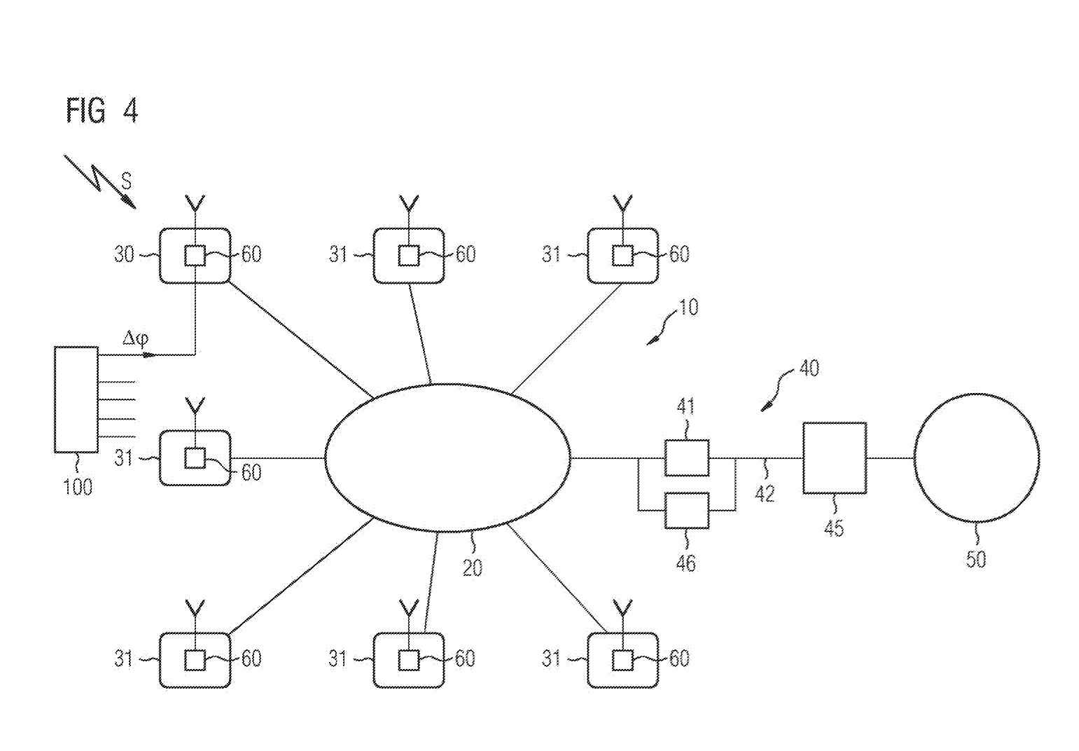

FIG. 4 shows an exemplary embodiment of a power plant according to the invention, in which a central device is provided which presets an individual setpoint phase angle on each of the energy generation units, and in which a HVDC transmission device has both a line-commutated rectifier and a self-commutated rectifier on the internal AC voltage grid side.

In the figures, in the interests of clarity, identical or comparable components carry the same reference numbers in each case.

FIG. 1 shows a power plant 10, which has an internal AC voltage grid 20 and a multiplicity of energy generation units 30 and 31 which are connected to the internal AC voltage grid 20. The internal AC voltage grid 20 is also connected to a HVDC transmission device 40, which connects the internal AC voltage grid 20 to an external AC voltage grid 50, and enables energy transmission from the internal AC voltage grid 20 in the direction of the external AC voltage grid 50.

On the side of the internal AC voltage grid 20, the HVDC transmission device 40 is a line-commutated transmission device and, to this end, has a line-commutated rectifier 41, which is arranged electrically between the internal AC voltage grid 20 and a DC transmission line 42.

To ensure the correct operation of the line-commutated rectifier 41 of the HVDC transmission device 40, it is necessary that the internal AC voltage grid 20 is sufficiently stable. In order to ensure the stability of the internal AC voltage grid 20, notwithstanding the multiplicity of energy generation units 30 and 31 present, each of the energy generation units 30 and 31 is equipped with a synchronization device 60, which is designed to regulate the generation of the output voltage of the respective energy generation unit or the injection of the output current by the respective energy generation unit, such that the phase angle of the output voltage or the phase angle of the output current corresponds to a setpoint phase angle which is preset on the respective energy generation unit. To this end, the setpoint phase angle is determined with reference to an input-side synchronization signal S, which is fed to the synchronization devices 60 of the energy generation units 30 or 31.

In the exemplary embodiment shown in FIG. 1, wireless transmission of the synchronization signal S to the synchronization devices 60 is assumed. Alternatively, it is possible for the synchronization signal S to be transmitted by other means, for example via a wired connection.

The injection of electric power into the internal AC voltage grid 20 by the energy generation units 30 or 31 proceeds either via a power electronics converter, or via the stator of a double-fed asynchronous machine, the rotor of which is supplied by a power electronics converter. In the interests of clarity, these last mentioned components, namely the power electronics converters or the stators of double-fed asynchronous machines, are not explicitly represented in FIG. 1.

With regard to the configuration of the HVDC transmission device 40, it is considered advantageous that this should be a self-commutated transmission device on the side of the external AC voltage grid 50 and, to this end, has a self-commutated converter 45.

The power plant 10 represented in FIG. 1 may be operated, for example, as follows:

The synchronization devices 60 of the energy generation units 30 or 31 receive the synchronization signal S, which may, by way of example, be a generally-known GPS location signal (GPS: global positioning system), as the GPS location signal incorporates a time stamp which is suitable for synchronization purposes.

The synchronization devices 60 analyze the synchronization signal S, and regulate the output voltage or output current of their respective energy generation unit such that the phase angle of the output voltage or the phase angle of the output current coincides with a setpoint phase angle which is individually preset on the energy generation unit, in relation to the input-side synchronization signal S.

By synchronization using the synchronization signal S, it is therefore possible for the energy generation units, without being directly interconnected, to show coordinated behavior in respect of the injection of their energy into the internal AC voltage grid 20. Due to the synchronicity of energy injection, the internal AC voltage grid 20 can be stabilized in respect of the network frequency and voltage level, such that the internal AC voltage grid 20, or the stability thereof, is sufficient for the stable operation of the line-commutated rectifier 41, and for the transmission of energy from the internal AC voltage grid 20 via the line-commutated rectifier 41 and the DC transmission line 42 in the direction of the external AC voltage grid 50.

FIG. 2 shows a further exemplary embodiment of a power plant, in which the energy generation units 30 and 31 are synchronized by means of a synchronization signal S, in order to ensure sufficient stabilization of the internal AC voltage grid 20 to permit a line-commutated operation of the line-commutated rectifier 41.

Unlike the exemplary embodiment shown in FIG. 1, the power plant 10 shown in FIG. 2, on the connection side of the HVDC transmission device 40 facing the internal AC voltage grid 20, also has a self-commutated rectifier 46, which is capable of functioning as an inverter and of injecting energy from the DC transmission line 42 into the AC voltage grid 20. Accordingly, the self-commutated rectifier 46 can be used to cover the internal load demand of the internal AC voltage grid 20 by means of an energy transfer from the external AC voltage grid 50 in the direction of the internal AC voltage grid 20 when, for example, the energy generation units 30 or 31 cannot themselves inject sufficient power into the internal AC voltage grid 20.

FIG. 3 shows an exemplary embodiment of a power plant 10 incorporating a central device 100, which is individually connected to each of the energy generation units 30 or 31, whether by wired connection or by means of a wireless link. In the interests of clarity, only the connection between the energy generation unit 30 and the central device 100 is explicitly represented in FIG. 1; the remaining connections between the energy generation units 31 and the central device 100 are only implied in FIG. 1.

The function of the central device 100 is the presetting of an individual phase angle Δφ on each of the energy generation units 30 or 31, or on each synchronization device 60 of the energy generation units 30 and 31. Accordingly, in addition to the synchronization signal S, each of the synchronization devices 60 also receives its individually preset setpoint phase angle Δφ, thereby permitting the regulation of the output voltage or the output current such that the latter assumes the preset setpoint phase angle Δφ, in relation to the input-side synchronization signal S.

In the exemplary embodiment shown in FIG. 3, the synchronization signal S is transmitted as a GPS signal via a wireless link, and the transmission of the individually preset setpoint phase angle Δφ is effected by the central device 100, by means of a wired connection or a wireless link. Alternatively, it is possible for the synchronization signal S to be transmitted in combination with the individual setpoint phase angle Δφ from the central device 100 to the synchronization devices 60 of the energy generation units 30 or 31, for example by wired connection or by wireless transmission. In the case of transmission via a wired connection, radio receiver devices for the reception of a GPS signal, for example, may be omitted.

FIG. 4 shows an exemplary embodiment of a power plant, in which the HVDC transmission device 40 on the side of the internal AC voltage grid 20, in addition to the line-commutated rectifier 41, also has a self-commutated rectifier 46, which is designed to function as an inverter and, for the coverage of the internal load demand of the internal AC voltage grid 20, to inject energy from the DC side of the rectifier 46 or from the DC transmission line 42 into the internal AC voltage grid 20, as already described above with reference to FIG. 2. The comments indicated in respect thereto apply correspondingly.

Although the invention has been illustrated and described in greater detail with reference to preferred exemplary embodiments, the invention is not restricted to the examples disclosed, and further variations may be inferred by the person skilled in the art, whilst remaining within the scope of protection of the invention.

### LIST OF REFERENCE SYMBOLS

10 Power plant
20 Internal AC voltage grid
30 Energy generation unit
31 Energy generation unit
40 HVDC transmission device
41 Line-commutated rectifier
42 DC transmission line
45 Self-commutated converter
46 Self-commutated rectifier
50 External AC voltage grid
60 Synchronization device
100 Central device
S Synchronization signal
Δφ Setpoint phase angle

1-15. (canceled)

16. A power plant, comprising:
an internal AC voltage grid;
a multiplicity of electrical energy generation units being connected to said internal AC voltage grid, said electrical energy generation units each having at least one of a power electronics converter or a double-fed asynchronous machine with a stator and a rotor;
at least one HVDC transmission device connected to said internal AC voltage grid, and being connectable to an external AC voltage grid via a DC link, said at least one HVDC transmission device enables energy transmission from said internal AC voltage grid in a direction of the external AC voltage grid;
said energy generation units either feed power into said internal AC voltage grid via said power electronics converter, or feed the power into said internal AC voltage grid via said stator of said double-fed asynchronous machine, said rotor of said double-fed asynchronous machine is fed via said power electronics converter; and
each of said energy generation units having a synchronization device suitable for regulating a generation of an output voltage of a respective energy generation unit or for regulating a feeding of an output current by said respective energy generation unit such that a phase angle of the output voltage or a phase angle of the output current has a setpoint phase angle which is preset to said respective energy generation unit, with respect to a synchronization signal applied on an input side of each of said energy generation units.

17. The power plant according to claim 16, wherein said HVDC transmission device has a connection side with at least one line-commutated rectifier connected to said internal AC voltage grid.

18. The power plant according to claim 16, wherein said HVDC transmission device is a line-commutated HVDC transmission device.

19. The power plant according to claim 16, wherein said HVDC transmission device, on a side of said internal AC voltage grid, is a line-commutated HVDC transmission device and, on a side of said external AC voltage grid, is a self-commutated HVDC transmission device.

20. The power plant according to claim 16, wherein said HVDC transmission device on a connection side to said internal AC voltage grid has at least one self-commutated rectifier which is capable of functioning as an inverter and, for a coverage of an internal load demand of said internal AC voltage grid, can inject energy delivered on a DC side of said HVDC transmission device into said internal AC voltage grid.

21. The power plant according to claim 16, wherein all of said energy generation units in the power plant receive a same said synchronization signal.

22. The power plant according to claim 16, wherein during an operation of the power plant, at least one half of said energy generation units is preset to a same said setpoint phase angle, hereinafter designated as a central setpoint phase angle, and said half of said energy generation units generates the output voltage or the output current with a same said central setpoint phase angle.

23. The power plant according to claim 22, wherein at least one of said energy generation units is preset, or can be preset, to an individual setpoint phase angle which deviates from said central setpoint phase angle.

24. The power plant according to claim 23, wherein at least one of said energy generation units is preset to said individual setpoint phase angle which deviates from the central setpoint phase angle by 90°, or at least deviates therefrom such that said one energy generation unit injects reactive power into said internal AC voltage grid.

25. The power plant according to claim 16, further comprising a central device which is connected to all of said energy generation units and is configured for presetting of a respective setpoint phase angle on each of said energy generation units.

26. The power plant according to claim 16, wherein each of said energy generation units has a radio receiver, and said radio receivers of said energy generation units receive their respective synchronization signal by wireless transmission.

27. The power plant according to claim 26, wherein said radio receivers are GPS receivers.

28. The power plant according to claim 16, wherein:
said energy generation units are selected from the group consisting of wind turbines and photovoltaic installations; and
the power plant is selected from the group consisting of a wind farm and a photovoltaic park.

29. An energy generation unit for a power plant, the energy generation unit comprising:
a synchronization device configured for processing an input-side synchronization signal and for regulating a phase angle of an output voltage generated by the energy generation unit, or a phase angle of an output current injected by the energy generation unit into an internal AC voltage grid of the power plant, said synchronization device regulating a generation of the output voltage or the injection of the output current such that the phase angle of the output voltage or the phase angle of the output current corresponds to a setpoint phase angle which is preset on the energy generation unit.

30. A method for operating a power plant equipped with an internal AC voltage grid, a multiplicity of energy generation units connected to the internal AC voltage grid, and at least one HVDC transmission device connected to the internal AC voltage grid, which comprises the steps of:
feeding a synchronization signal to each of the energy generation units;
detecting, via each of the energy generation units, the synchronization signal received on an input side, together with a phase angle of an output voltage generated by a respective energy generation unit, or a phase angle of an output current injected into the internal AC voltage grid by the respective energy generation unit; and
regulating a generation of the output voltage or the injection of the output current such that the phase angle of the output voltage or the phase angle of the output current corresponds to a setpoint phase angle which is preset on the respective energy generation unit, in relation to the synchronization signal.
